(19) United States
(12) Patent Application Publication
(10) Pub. No.: US 2010/0232637 A1
(43) Pub. Date: Sep. 16, 2010

(54) SPEAKER DEVICE

(75) Inventors: Hiroshi Kowaki, Kobe-shi (JP); Yoshikuni Miki, Kobe-shi (JP); Ryohsuke Sou, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi, Hyogo (JP)

(21) Appl. No.: 12/734,008

(22) PCT Filed: Oct. 6, 2008
(86) PCT No.: PCT/JP2008/068181

§ 371 Date: Apr. 2, 2010

(30) Foreign Application Priority Data
Oct. 5, 2007 (JP) 2007-261841

(51) Int. Cl. H04R 1/02

(52) U.S. Cl. 381/386

(57) ABSTRACT

A speaker device including: a first speaker; a second speaker opposed to the first speaker; a speaker box housing the first speaker and the second speaker; a coupling portion which couples the first speaker and the second speaker to each other; and a vibration-transmitting chamber provided between the first speaker and the second speaker, in which the vibration-transmitting chamber communicates with an opening portion formed in the speaker box.

### FIELD

The present invention relates to a speaker device.

### BACKGROUND

For the purpose of improving acoustic characteristics and sound quality, various technologies regarding the speaker device are proposed. For example, Patent document 1 discloses a technology of fixing a back surface portion of a first speaker and a back surface portion of a second speaker to each other with fixing means. Here, FIG. 1 is a schematic sectional view of a speaker disclosed in Patent document 1. As illustrated in FIG. 1, the speaker described in Patent document 1 includes a first speaker 110a and a second speaker 110b. The first speaker 110a includes a vibration plate 101a, a voice coil 102a, a magnetic circuit 103a, and the like. The second speaker 110b includes a vibration plate 101b, a voice coil 102b, a magnetic circuit 103b, and the like similarly to the first speaker 110a. The magnetic circuit 103a of the first speaker 110a and the magnetic circuit 103b of the second speaker 110b are coupled to each other by a shaft 104 (fixing means) with an interval therebetween. According to the technology described in Patent document 1, with the configuration as described above, vibration of the magnetic circuits 103a, 103b is efficiently suppressed. Consequently, it is possible to effectively increase acoustic conversion efficiency of the vibration plates 101a, 101b.
[Patent document 1] JP 2007-53798 A
[Patent document 2] JP 2682989 B
[Patent document 3] JP 09-238393 A

### SUMMARY

In a conventional speaker, vibration of the speaker is easily transmitted to a speaker box. Consequently, out-of-phase sound is generated from the speaker box, and hence there is a fear that the sound quality is deteriorated. Further, in the conventional speaker, a magnetic circuit side of the speaker is not fixed, and hence the speaker easily vibrates. Thus, energy is not efficiently transmitted from the vibration plates to the air, and hence there is a fear that transient characteristics of sound are deteriorated.

In order to solve the above-mentioned problems, there is disclosed the technology of fixing the back surface portion of the first speaker and the back surface portion of the second speaker to each other with the fixing means. According to the technology, it is possible to efficiently suppress the vibration of the magnetic circuit arranged on the back surface portion of each of the speakers, and to effectively increase the acoustic conversion efficiency of the vibration plates. Note that, in the technology, a front side of each of the speakers is opened, and hence there may arise a phenomenon that the air pushed by each of the speakers escapes to sides of each of the speakers. Therefore, if such escape of the air can be suppressed, the acoustic conversion efficiency of the vibration plates can be further increased.

In view of the above-mentioned circumstances, an object of the present invention is therefore to provide a technology regarding a speaker device capable of providing sound with excellent quality by achieving a greater increase in acoustic conversion efficiency.

In order to solve the problems described above, in the present invention, two speakers are arranged with a predetermined interval therebetween so as to be opposed to each other, and the two speakers are fixed to each other through a coupling portion. Moreover, walls are formed around a space formed between the two speakers, and thus escape of the air is suppressed. That is, the present invention provides a speaker device including: a first speaker; a second speaker opposed to the first speaker; a speaker box housing the first speaker and the second speaker; a coupling portion which couples the first speaker and the second speaker to each other; and a vibration-transmitting chamber provided between the first speaker and the second speaker, in which the vibration-transmitting chamber communicates with an opening portion formed in the speaker box.

More specifically, the present invention provides a speaker device including: a first speaker; a second speaker to which a signal in phase with a signal input to the first speaker is input, the second speaker being arranged with an interval so as to be opposed to the first speaker; a coupling portion which couples a back surface portion of the first speaker and a back surface portion of the second speaker to each other; a vibration-transmitting chamber surrounding a space formed between the first speaker and the second speaker so as to suppress escape of the air contained in the space when the first speaker and the second speaker vibrate; an opening portion formed in the vibration-transmitting chamber, which allows the air to which vibration is transmitted in the vibration-transmitting chamber to be emitted therefrom to an outside thereof as an acoustic wave; and a box-like speaker box housing the first speaker and the second speaker.

According to the present invention, through coupling the back surface portions of the two speakers to each other through the coupling portion, it is possible to reduce the vibration of the back surface portions of the speakers, and to increase the acoustic conversion efficiency. Further, according to the present invention, the vibration-transmitting chamber is provided, and hence it is possible to efficiently compress the air between the first speaker and the second speaker, in other words, it is possible to efficiently transmit the vibration of the vibration plate of each of the first speaker and the second speaker to the air. As a result, it is possible to increase the acoustic conversion efficiency.

The first speaker may be constituted by a conductive speaker which generates an acoustic wave with use of a force generated between a magnetic field and an electric current. The second speaker may be similarly constituted by a conductive speaker. It is unnecessary that the first speaker and the second speaker should be completely the same. However, it is preferred that each of the first speaker and the second speaker have a cone with the same diameter and a magnetic circuit with the same diameter.

The first speaker and the second speaker are arranged with an interval therebetween so that front sides (vibration plate sides) of the first speaker and the second speaker are opposed to each other. Further, in-phase signals are input to the first speaker and the second speaker, respectively, and the two speakers are coupled to each other through the coupling portion. As a result, the two speakers are driven in phase. Note that, in the conventional speaker, the back surface portion of the speaker is not fixed, and hence the speaker easily vibrates. Thus, there is a problem that energy efficiency in transmitting from the vibration plates to the air is reduced due to the vibration of the magnetic circuit portion arranged on the back surface portion. In contrast, according to the present invention, the back surface portions of the two speakers are coupled to each other through the coupling portion, and the vibration of the back surface portions is reduced through the coupling portion. Therefore, the energy efficiency in transmitting from the vibration plates to the air, i.e., the acoustic conversion efficiency can be increased.

The vibration-transmitting chamber surrounds the space formed between the first speaker and the second speaker. That is, according to the present invention, the air contained in the space formed between the first speaker and the second speaker is suppressed from escaping to the outside when the speakers vibrate. Thus, the energy is effectively transmitted to the air. In other words, the acoustic conversion efficiency of the vibration plates is increased. Further, a wavelength of the vibration is long in reproduction of low-frequency sound. Thus, the air tends to escape in comparison with a case of reproduction of high-frequency sound, and there is a fear that the energy efficiency in transmitting from the vibration plates to the air is reduced. However, according to the present invention, the vibration-transmitting chamber is provided, and hence the vibration is reliably transmitted to the air contained in the space formed between the first speaker and the second speaker. Consequently, the acoustic conversion efficiency can be increased in the reproduction of low-frequency sound.

The vibration-transmitting chamber has the opening portion formed therein, and the air to which the vibration is transmitted is emitted as the acoustic wave to the outside of the speakers. As a result, a listener can listen to sound generated from the speakers of the present invention.

The speaker box is a so-called speaker box housing the first speaker and the second speaker. The above-mentioned vibration-transmitting chamber is also provided in the speaker box. It is preferred that the speaker box have a sealed space formed independently of the vibration-transmitting chamber. With this configuration, it is possible to prevent interference between an acoustic wave emitted from the vibration-transmitting chamber, i.e., an acoustic wave generated forward from each of the first speaker and the second speaker, and an acoustic wave generated from the back surface portion of each of the first speaker and the second speaker. As a result, it is possible to provide sound with excellent quality to a listener. Note that a shape of the speaker box is not particularly limited, and may be a rectangular parallelepiped shape, cylindrical shape, etc.

Here, according to the present invention, in addition to the above-mentioned configuration, the speaker device may further include a speaker support section arranged in the speaker box, which supports the first speaker and the second speaker so as to prevent the first speaker and the second speaker from being held in contact with walls forming the speaker box.

The speaker support section is arranged in the speaker box, and supports the speakers. More specifically, in order to arrange the first speaker and the second speaker, which are coupled to each other through the coupling portion, at predetermined intervals from wall portions of the speaker box so as to prevent the two speakers from being held in contact with the wall portions at the time of vibration, the speaker support section supports the two speakers coupled to each other through the coupling portion. According to the present invention, the coupled two speakers are not directly fixed to the speaker box, and hence it is possible to suppress generation of so-called box resonance (incidental sound) which arises as a problem when the speakers are directly fixed to a conventional speaker box. As a result, it is possible to improve articulation of sound.

Further, in the present invention, the speaker support section may support the first speaker and the second speaker in a floating state.

As described above, according to the present invention, the speaker support section supports the speakers so as to prevent the speakers from being held in contact with the wall portion of the speaker box, and hence it is possible to suppress the generation of box resonance. Note that the first speaker and the second speaker vibrate together. However, if the vibration of the speakers can be absorbed, it is possible to suppress transmission of the vibration to the speaker box, and to further improve the articulation of sound. In this context, in the present invention, the speakers are supported in the floating state. In order to support the speakers in the floating state, for example, felt or the like may be provided to a connecting portion between the speaker support section and each of the speakers. With this configuration, in the present invention, the speakers are supported in the floating state, and the vibration of the speakers is absorbed without being transmitted to the speaker box. As a result, it is possible to suppress the so-called box resonance, and to further improve the articulation of sound. Further, it is preferred that portions supporting the speakers in the floating state have a hermetic sealing property. Note that, through providing the felt or the like to the connecting portion between the speaker support section and each of the speakers, the speakers can be supported in the floating state, and the hermetic sealing property can be maintained.

Further, in the present invention, the coupling portion may pass through a vibration plate of the first speaker and a vibration plate of the second speaker, one end of the coupling portion may be connected to part of a magnetic circuit portion of the back surface portion of the first speaker, and another end of the coupling portion may be connected to part of a magnetic circuit portion of the back surface portion of the second speaker.

In the conventional speaker, the magnetic circuit portion provided on the back surface portion of each of the speakers is not fixed in many cases. As a result, the vibration of the magnetic circuit portion inhibits the vibration of the vibration plate of each of the speakers, and thus the acoustic conversion efficiency of the vibration plate is reduced. In contrast, in the present invention, the magnetic circuit portions of the speakers are coupled to each other through the coupling portion, and hence it is possible to reduce the vibration of the magnetic circuit portions at the coupling portion, and to increase the acoustic conversion efficiency of the vibration plates. Note that, as part of each of the magnetic circuit portions, a magnetic body and a magnet are exemplified.

Further, according to the present invention, in addition to the above-mentioned configuration, the speaker device may further include a buffer portion provided to each of a connecting portion between part of walls forming the vibration-transmitting chamber and the first speaker, and a connecting portion between another part of the walls forming the vibration-transmitting chamber and the second speaker, the buffer portion allowing the vibration of the first speaker and the second speaker.

The first speaker and the second speaker vibrate, and hence it is preferred that the connecting portion between the vibration-transmitting chamber and each of the speakers have a configuration allowing the vibration of the speakers. In this context, in the present invention, the buffer portion is provided to the connecting portion between the vibration-transmitting chamber and each of the speakers. Thus, the vibration of the speakers is allowed. Note that the buffer portion may have a function of suppressing the air contained in the vibration-transmitting chamber from leaking through a gap formed in the connecting portion between the vibration-transmitting chamber and each of the speakers.

Further, in the present invention, the speaker box may include a first sealed chamber confining therein an acoustic wave generated backward from the first speaker, and a second sealed chamber confining therein an acoustic wave generated backward from the second speaker.

According to the present invention, it is possible to prevent the interference between the acoustic wave emitted from the vibration-transmitting chamber, i.e., the acoustic wave generated forward from each of the first speaker and the second speaker, and the acoustic wave generated backward from each of the speakers. As a result, it is possible to provide sound with excellent quality to a listener. According to the present invention, it is possible to provide a technology regarding a speaker device capable of providing sound with excellent quality by achieving a greater increase in acoustic conversion efficiency.

### BRIEF DESCRIPTION OF THE DRAWINGS

FIG. 1 is a schematic sectional view of a conventional speaker device.

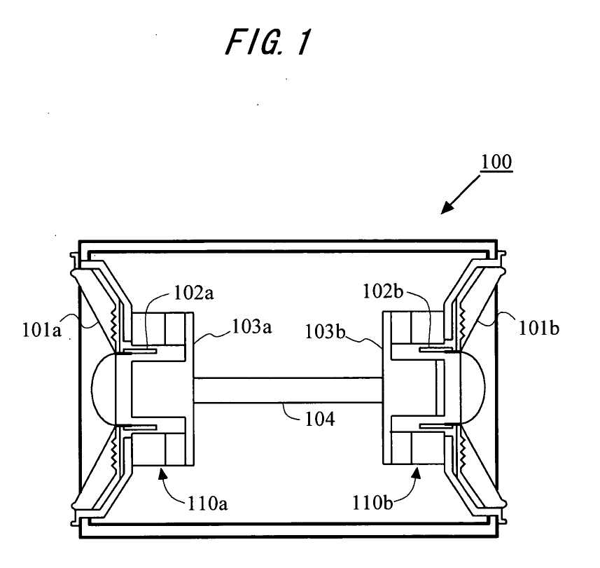

FIG. 2 is a schematic sectional view of a speaker device according to an embodiment.

FIG. 3 is a sectional view taken along the line A-A of FIG. 2.

FIG. 4 is a front view of the speaker device.

FIG. 5 is an enlarged view of a connecting portion between a first speaker and a first partitioning member.

FIG. 6 is a view illustrating flows of acoustic waves when the speaker device is operated.

FIG. 7 is a schematic sectional view of a speaker device according to a modification.

### DESCRIPTION OF EMBODIMENTS

Next, a speaker device according to an embodiment of the present invention is described with reference to the drawings.

<Configuration>

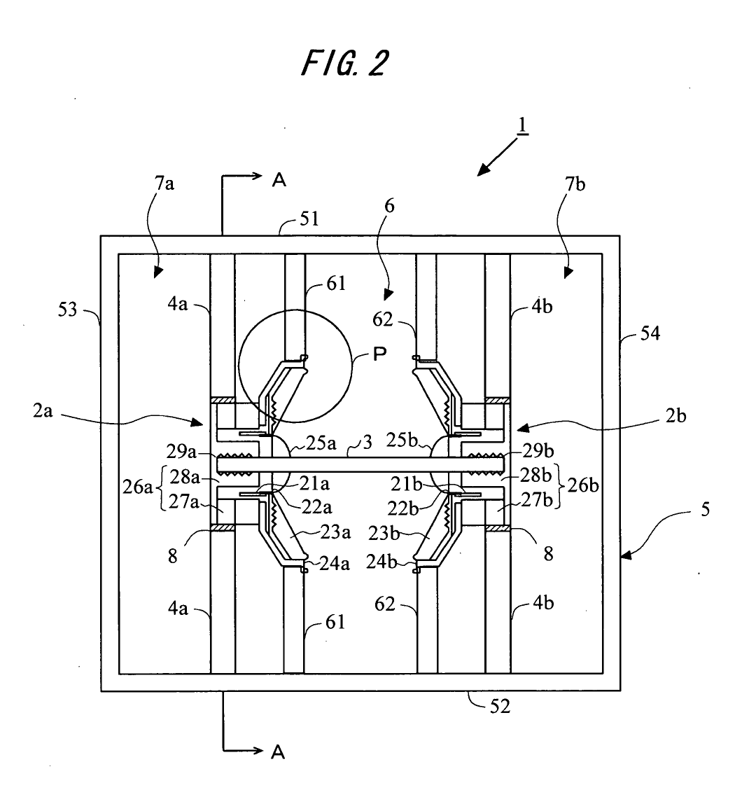

FIG. 2 is a schematic sectional view of the speaker device to an embodiment. Note that FIG. 2 illustrates a vertical section of the speaker device in its front view. As illustrated in FIG. 2, a speaker device 1 includes a first speaker 2a, a second speaker 2b, a shaft 3 (corresponding to a coupling portion of the present invention) coupling the first speaker 2a and the second speaker 2b to each other, a first support portion 4a supporting the first speaker 2a, a second support portion 4b supporting the second speaker 2b, and a speaker box 5 housing the first speaker 2a and the second speaker 2b therein. In the speaker box 5, there are provided a vibration-transmitting chamber 6 enclosing the air contained in a space between the first speaker 2a and the second speaker 2b, a first sealed chamber 7a provided behind the first speaker 2a, and a second sealed chamber 7b provided behind the second speaker 2b.

The speaker box 5 is formed into a rectangular parallelepiped shape, and includes a top plate 51, a bottom plate 52, side plates 53, 54, a front plate 55 (on a near side of the plane of paper), and a back plate 56 (on a deep side of the plane of paper). Note that a shape of the speaker box 5 is not limited thereto. The speaker box 5 may be formed into, for example, a cylindrical shape.

The first speaker 2a includes a voice coil 21a inserted in a magnetic gap (not shown), a voice coil bobbin 22a transmitting the vibration of the voice coil 21a, a cone-type vibration plate 23a generating as an acoustic wave the vibration transmitted through the voice coil bobbin 22a, a frame 24a holding the cone-type vibration plate 23a, and a center cap 25a which is attached to the cone-type vibration plate 23a and prevents deformation in a radial direction of the cone-type vibration plate 23a and intrusion of dust, etc. Further, a magnetic circuit 26a is provided on a back surface of the first speaker 2a. The magnetic circuit 26a includes an annular magnet 27a, and a yoke 28a as a magnetic body constituted by a disk-like portion and a columnar portion, the columnar portion being arranged inside the annular magnet 27a. In the following, a configuration of each component is described in detail.

The second speaker 2b has a configuration similar to that of the first speaker 2a. In the embodiment, the first speaker 2a and the second speaker 2b have the same configuration. Note that, herein, the first speaker 2a and the second speaker 2b are denoted by the same reference numeral. Further, components of the first speaker 2a are denoted by the reference numeral suffixed with “a”, and components of the second speaker 2b are denoted by the reference numeral suffixed with “b”. It is unnecessary that the first speaker 2a and the second speaker 2b should be completely the same. However, it is preferred that a diameter of the cone-type vibration plate 23a and a diameter of the magnetic circuit 26a be the same.

The first speaker 2a and the second speaker 2b are coupled by the shaft 3 while being arranged with an interval therebetween so as to be opposed to each other. Specifically, the shaft 3 passes through cone-type vibration plates 23a, 23b and center caps 25a, 25b. One end of the shaft 3 is connected to the yoke 28a of the magnetic circuit 26a of the first speaker 2a, and the other end of the shaft 3 is connected to a yoke 28b of a magnetic circuit 26b of the second speaker 2b. In the embodiment, holes 29a, 29b into which the shaft 3 is inserted are respectively formed at centers of the columnar portions of the yokes 28a, 28b arranged inside the annular magnets 27a, 27b. In the embodiment, thread grooves are respectively formed in the holes 29a, 29b, and thread grooves to be connected to the holes 29a, 29b are also formed in both end portions of the shaft 3, respectively. Thus, there is obtained a configuration in which a connecting state of the first speaker 2a and the second speaker 2b with the shaft 3 can be more stably maintained. A material of the shaft 3 is not particularly limited, and the shaft 3 may be made of, for example, metal. When the shaft 3 is made of aluminum, it is possible to obtain a shaft with small weight and sufficient strength.

The first speaker 2a and the second speaker 2b coupled by the shaft 3 are supported by a speaker support section 4 provided in the speaker box 5. The speaker support section 4 in the embodiment includes the first support portion 4a supporting the first speaker 2a, and the second support portion 4b supporting the second speaker 2b. The first support portion 4a and the second support portion 4b have a similar configuration, and hence the first support portion 4a is described as an example here. The first support portion 4a is formed of a plate-like member, and has a support hole 41a formed in substantially a center thereof to allow the annular magnet 27a of the first speaker 2a to be inserted therein.

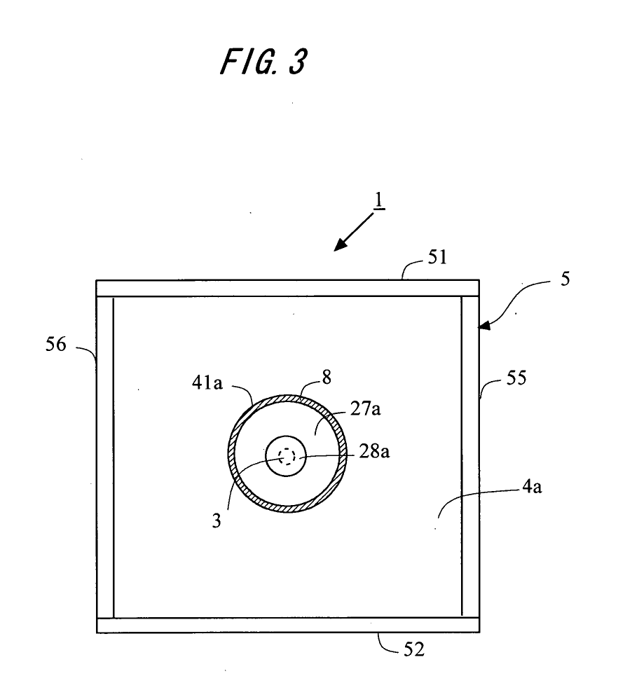

Here, FIG. 3 is a sectional view taken along the line A-A of FIG. 2. As illustrated in FIG. 3, the first support portion 4a is formed of a rectangular plate-like member, and has, at a center portion thereof, the support hole 41a with a diameter larger than a contour of the annular magnet 27a of the first speaker 2a. In a gap formed between the support hole 41a and the annular magnet 27a, a support buffer portion 8 made of felt is arranged so as to fill the gap. With this configuration, the first speaker 2a can be supported in a floating state. Further, a hermetic sealing property of the first sealed chamber 7a described below can be maintained. Note that the support buffer portion 8 may be made of a material which is flexible and capable of maintaining the hermetic sealing property and of absorbing the vibration of the first speaker 2a. In the embodiment, felt is used as the material of the support buffer portion 8, but polyethylene foam (PEF) may be used in place of felt.

Next, the vibration-transmitting chamber 6 is described. Between the first speaker 2a and the second speaker 2b, the vibration-transmitting chamber 6 enclosing the air contained in the space therebetween is provided. The vibration-transmitting chamber 6 is formed by a first partitioning member 61 held in contact with an outer end portion of the frame 24a of the first speaker 2a, a second partitioning member 62 held in contact with an outer end portion of a frame 24b of the second speaker 2b, and part of the top plate 51, the bottom plate 52, and the back plate 56 (on the deep side of the plane of paper) of the speaker box 5. On the near side of the plane of paper, there is formed an opening portion 57 (which is not shown in FIG. 2) through which the air to which the vibration is transmitted in the vibration-transmitting chamber 6 is emitted as the acoustic wave.

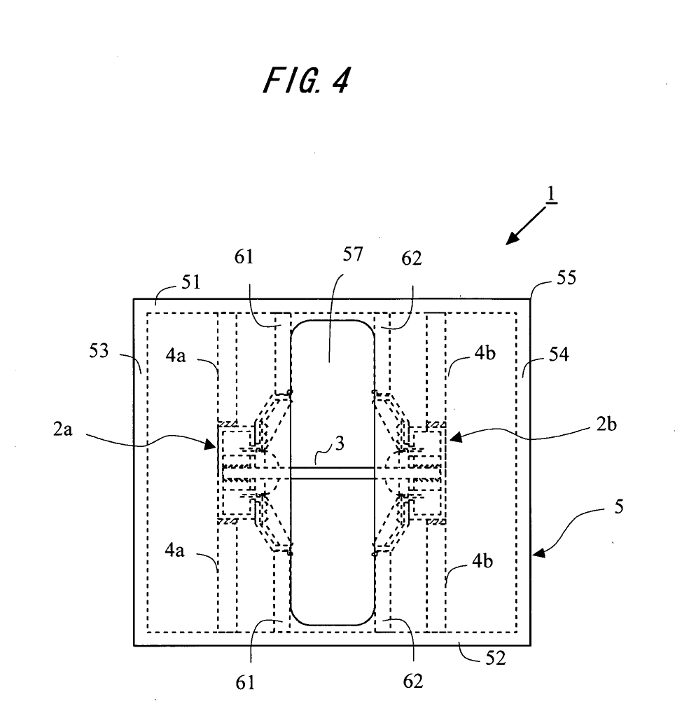

Here, FIG. 4 is a front view of the speaker device 1. Note that, in FIG. 4, a component arranged inside the speaker box 5, such as the first speaker 2a, is indicated by a dotted line. In the embodiment, the opening portion 57 is formed to be slightly smaller in height than the speaker box 5, and the opening portion 57 is formed to have a width corresponding to an interval between the outer end portion of the frame 24a of the first speaker 2a and the outer end portion of the frame 24b of the second speaker 2b, in other words, an interval between the first partitioning member 61 and the second partitioning member 62. Shapes of the vibration-transmitting chamber 6 and the opening portion 57 are not particularly limited. In the embodiment, walls (top plate 51 and the like) of the speaker box 5 are used as part of walls of the vibration-transmitting chamber 6. However, without use of the walls of the speaker box 5, the space formed between the first speaker 2a and the second speaker 2b may be entirely enclosed by a partitioning member different from the walls of the speaker box 5. That is, it is only necessary that the vibration-transmitting chamber 6 can enclose the air contained in the space formed between the first speaker 2a and the second speaker 2b and allow the same to be independent from the air contained in the speaker box 5. A mode of the vibration-transmitting chamber 6 is not particularly limited.

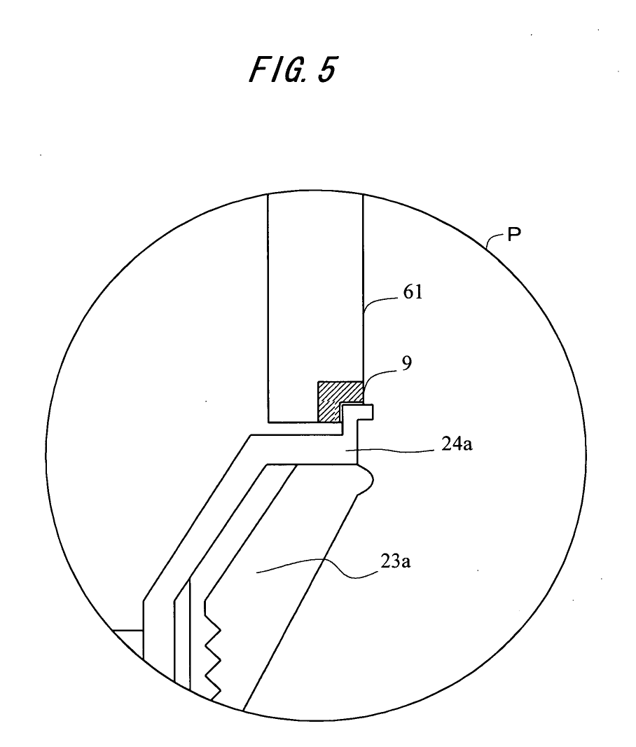

Note that, in a connecting portion between the first partitioning member 61 and the outer end portion of the frame 24a of the first speaker 2a, there is provided a buffer portion 9 allowing the vibration of the first speaker 2a. Here, FIG. 5 is an enlarged view of a circle P of FIG. 2, which illustrates the connecting portion between the first speaker 2a and the first partitioning member 61. As illustrated in FIG. 5, in the embodiment, the buffer portion 9 is made of felt, and formed into an L-shape in section. Note that the buffer portion 9 only needs to be able to allow the vibration of the first speaker 2a, and a shape and a material thereof are not limited. For example, polyethylene foam (PEF) may be used in place of felt.

Next, the first sealed chamber 7a and the second sealed chamber 7b are described. Note that the first sealed chamber 7a and the second sealed chamber 7b basically have a similar configuration, and hence the first sealed chamber is described as an example here. The first sealed chamber 7a is formed into a rectangular parallelepiped. Of six wall surfaces forming the rectangular parallelepiped, five wall surfaces are constituted by the walls of the speaker box 5, and only one wall surface is constituted by the first support portion 4a. That is, the first sealed chamber 7a is formed by the first support portion 4a and the top plate 51, the bottom plate 52, the side plate 53, the front plate 55, and the back plate 56 which constitute the walls of the speaker box 5 (see FIG. 2). The first support portion 4a supports the first speaker 2a as described above. In the embodiment, the first support portion 4a functions also as the wall of the first sealed chamber 7a. Further, as described above, the buffer portion 9 made of felt is provided to the support hole 41a of the first support portion 4a, and the hermetic sealing property of the first sealed chamber 7a is maintained. That is, the first sealed chamber 7a is arranged behind the first speaker 2a, and prevents the acoustic wave generated backward from the first speaker 2a from being emitted to the outside. As a result, interference between the acoustic wave generated backward from the first speaker 2a, and the acoustic wave which is generated forward from the first speaker 2a, i.e., from the vibration plate 26a and serves as the air to which the vibration is transmitted through the vibration-transmitting chamber 6. Consequently, it is possible to provide sound with excellent quality to a listener.

<Operation>

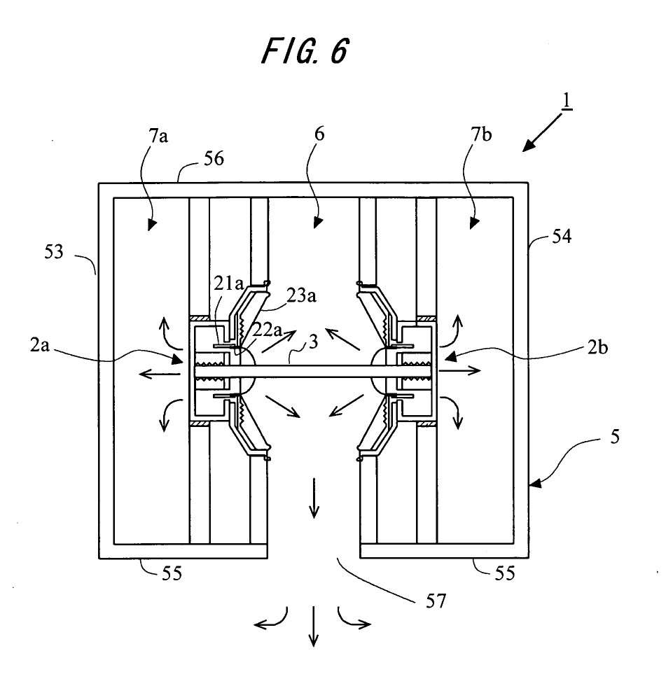

Next, an operation of the speaker device 1 according to the embodiment is described. In-phase signals are input to the first speaker 2a and the second speaker 2b, respectively, and thus the speaker device 1 in the embodiment is operated. Here, FIG. 6 illustrates flows of acoustic waves when the speaker device 1 is operated. A signal output from an audio apparatus (not shown) is supplied through wiring, and is input to a terminal of the first speaker 2a and a terminal of the second speaker 2b. The signal to be input is the in-phase signal, and the annular magnet 27a of the first speaker 2a and the annular magnet 27b of the second speaker 2b are magnetized such that the first speaker 2a and the second speaker 2b are driven in phase. Therefore, when an electric current passes through the voice coil 21a of the first speaker 2a, the voice coil 21a vibrates in a right-left direction in the plane of paper, and the vibration is transmitted to the cone-type vibration plate 23a through the voice coil bobbin 22a. The vibration of the cone-type vibration plate 23a is transmitted to the air contained in the vibration-transmitting chamber 6, and is emitted as the acoustic wave from the opening portion 57 to the outside. Note that, also in the second speaker 2b, the acoustic wave is emitted from the opening portion 57 after performing a process similar to that of the first speaker 2a. Meanwhile, the acoustic wave generated backward from the first speaker 2a is confined in the first sealed chamber 7a. Further, the acoustic wave generated backward from the second speaker 2b is confined in the second sealed chamber 7b.

<Effect>

In the speaker device 1 according to the embodiment described above, the yoke 28a provided on the back surface of the first speaker 2a and the yoke 28b provided on the back surface of the second speaker 2b are coupled to each other by the shaft 3, and hence the vibration of the magnetic circuits 26a, 26b including the yokes 28a, 28b can be reduced with the shaft 3. As a result, it is possible to increase acoustic conversion efficiency. Further, in the speaker device 1 according to the embodiment, the vibration-transmitting chamber 6 is provided, and hence the vibration generated from the respective speakers is efficiently transmitted to the air contained in the vibration-transmitting chamber 6. As a result, it is possible to increase the acoustic conversion efficiency. Moreover, the first speaker 2a and the second speaker 2b are supported in a floating state by the speaker support section 4, and hence it is possible to suppress transmission of the vibration of the speakers to the speaker box 5. As a result, it is possible to suppress generation of box resonance (incidental sound), and to improve articulation of sound.

<Modification>

In the speaker device 1 according to the embodiment, two sealed chambers, i.e., the first sealed chamber 7a and the second sealed chamber 7b, are formed inside the speaker box 5. However, only one sealed chamber may be formed inside the speaker box 5. That is, the sealed chamber only needs to be able to suppress the interference between the acoustic wave emitted from the vibration-transmitting chamber 6 (acoustic wave generated forward from each of the speakers), and the acoustic wave generated backward from each of the speakers. Therefore, for example, the speaker device 1 may have one sealed chamber in the speaker box 5, and the vibration-transmitting chamber 6 may be provided independently of the one sealed chamber.

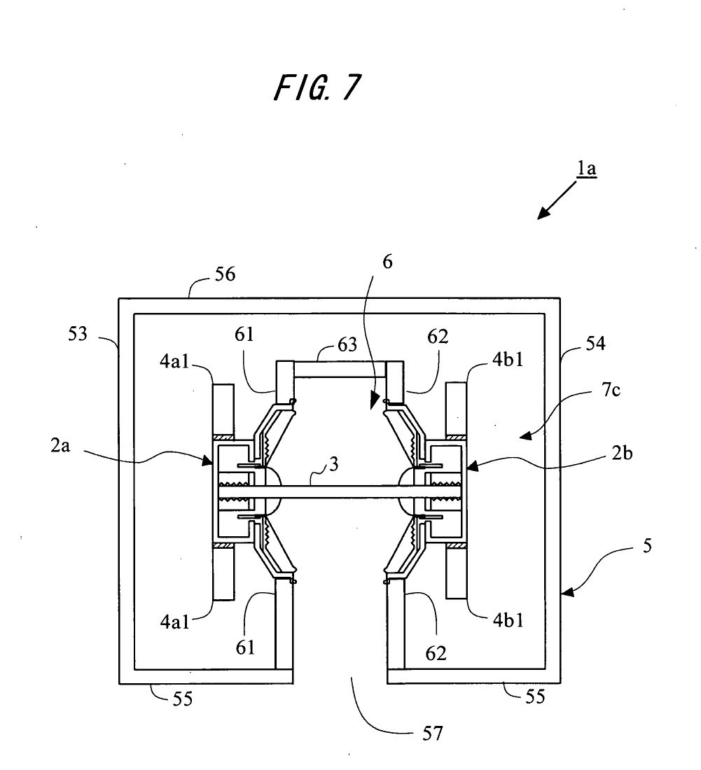

Here, FIG. 7 is a schematic sectional view of a speaker device la according to a modification. As illustrated in FIG. 7, similarly to the speaker device 1 described above, the speaker device la in the modification includes the first speaker 2a, the second speaker 2b, and the shaft 3, and the first speaker 2a and the second speaker 2b coupled to each other by the shaft 3 are provided in the speaker box 5. Note that different points are described below. The speaker device 1 is provided with two sealed chambers. In contrast, the speaker device 1 in the modification is provided with a sealed chamber 7c serving as one sealed chamber surrounding the vibration-transmitting chamber 6. Also in the above-mentioned mode, it is possible to suppress the interference between the acoustic wave emitted from the vibration-transmitting chamber 6, and the acoustic wave generated backward from each of the speakers.

Note that, in the speaker device 1 according to the embodiment, the first support portion 4a functions as a partitioning plate of the first sealed chamber 7a, and the second support portion 4b functions as a partitioning plate of the second sealed chamber 7b. Therefore, as the first support portion 4a and the second support portion 4b, there are respectively used plate-like members having the substantially same size as that of the side plates 53, 54 of the speaker box 5. However, in the speaker device la in the modification, it is at least necessary to be able to support the speakers in a floating state, and the first support portion 4a and the second support portion 4b may not function as the partitioning plates. Accordingly, a speaker support portion 4a1 of the speaker device 1a in the modification has the substantially same height as a height of the speaker box so that the speaker support portion 4a1 can be connected to the top plate 51 and the bottom plate 52 of the speaker box 5. Meanwhile, the speaker support portion 4a1 is formed to have a width smaller than a depth of the speaker box 5. A speaker support portion 4b1 has a configuration similar to that of the speaker support portion 4a1. In addition, a third partitioning plate 63 is provided as a partitioning plate forming the vibration-transmitting chamber 6. In comparison with the vibration-transmitting chamber 6 of the speaker device 1, the vibration-transmitting chamber 6 of the speaker device la is formed to have the smaller depth. As a result, a space formed behind the first speaker 2a and a space formed behind the second speaker 2b communicate with each other, to thereby form the sealed chamber 7c.

Preferred modes of the present invention are described above. However, the speaker device according to the present invention is not limited thereto. The present invention can include the combination of the modes as possible.

What is claimed is:

1. A speaker device, comprising:
a first speaker;
a second speaker opposed to the first speaker;
a speaker box housing the first speaker and the second speaker;
a coupling portion which couples the first speaker and the second speaker to each other; and
a vibration-transmitting chamber provided between the first speaker and the second speaker,
wherein the vibration-transmitting chamber communicates with an opening portion formed in the speaker box.

2. A speaker device, comprising:
a first speaker;
a second speaker to which a signal in phase with a signal input to the first speaker is input, the second speaker being arranged with an interval so as to be opposed to the first speaker;
a coupling portion which couples a back surface portion of the first speaker and a back surface portion of the second speaker to each other;
a vibration-transmitting chamber surrounding a space formed between the first speaker and the second speaker so as to suppress escape of the air contained in the space when the first speaker and the second speaker vibrate;
an opening portion formed in the vibration-transmitting chamber, which allows the air to which vibration is transmitted in the vibration-transmitting chamber to be emitted therefrom to an outside thereof as an acoustic wave; and
a box-like speaker box housing the first speaker and the second speaker.

3. The speaker device according to claim 1, further comprising a speaker support section arranged in the speaker box, which supports the first speaker and the second speaker so as to prevent the first speaker and the second speaker from being held in contact with walls forming the speaker box.

4. The speaker device according to claim 3, wherein the speaker support section supports the first speaker and the second speaker in a floating state.

5. The speaker device according to claim 1, wherein the coupling portion passes through a vibration plate of the first speaker and a vibration plate of the second speaker, one end of the coupling portion is connected to part of a magnetic circuit portion of the back surface portion of the first speaker, and another end of the coupling portion is connected to part of a magnetic circuit portion of the back surface portion of the second speaker.

6. The speaker device according to claim 1, further comprising a buffer portion provided to each of a connecting portion between part of walls forming the vibration-transmitting chamber and the first speaker, and a connecting portion between another part of the walls forming the vibration-transmitting chamber and the second speaker, the buffer portion allowing the vibration of the first speaker and the second speaker.

7. The speaker device according to claim 1, wherein the speaker box comprises a first sealed chamber confining therein an acoustic wave generated backward from the first speaker, and a second sealed chamber confining therein an acoustic wave generated backward from the second speaker.
